(19) United States
(12) Patent Application Publication
(10) Pub. No.: US 2012/0112902 A1
(43) Pub. Date: May 10, 2012

(54) System For Multiple Layered Security Within A Cargo Container

(75) Inventor: Richard C. Meyers, Longboat Key, FL (US)

(73) Assignee: System Planning Corporation, Arlington, VA (US)

(21) Appl. No.: 13/288,450

(22) Filed: Nov. 3, 2011

Related U.S. Application Data
(60) Provisional application No. 61/411,239, filed on Nov. 8, 2010.

(51) Int. Cl. G08B 1/08

(52) U.S. Cl. 340/539.1

(57) ABSTRACT

This invention describes layers of security sensors to determine the status of a container from point of departure to a final destination of the container. In particular, the present invention discloses the use of at least three levels of security applied to a single cargo container including an inductive sensor couples with an optical sensor to detect intrusions, a door switch sensor, and an RFID reader in communications with RFID tags embedded in the cargo and other sensors throughout the cargo hold. Security layering not only serves as a deterrent but also serves as an active defensive security system for establishing security “gates.”

### PRIORITY CLAIM

The present invention claims priority to U.S. Provisional Patent Application No. 61/411,239, filed Nov. 08, 2010. No new matter has been added.

### BACKGROUND OF THE PRESENT INVENTION

1. Field of the Present Invention

The present invention relates to a cargo container security system. More particularly, the present invention relates the use of multiple layers of security sensors to determine the status of a container from point of departure to a final destination of the container.

2. Description of Related Art

In today's security conscious transportation environment, there is a strong need to cost effectively monitor the contents and status of containerized shipments. This need exists both in the United States and abroad.

Shipping containers are used to transport most of the commerce entering, leaving, and transiting or moving within the Unites States. It is estimated that there are over 6 million containers moving in global commerce. Shipping containers have revolutionized the transportation of goods by greatly reducing the number of times goods must be loaded and unloaded during transport. However, at the same time, this same advantage has created a major problem in that it is very difficult to monitor and track the contents of each container during transport.

Monitoring the content of shipping containers is difficult because these containers are carried through numerous transit points and depots all over the world and it is impractical to stop and check the contents of each container individually at each point of transit. Dealing with the problem, the U.S. Customs Service estimates it can inspect just 5% of the 6 million containers entering and reentering the U.S. each year. Accordingly, agencies such as the United States Customs Service are seeking improved ways to achieve cargo container security and integrity upon arrival at the ports of entry of the United States.

To date, many government agencies have initiated programs to improve container security. These include many useful elements that are intended to preclude their use by terrorists. Current computer tracking systems are effective at monitoring the location of individual containers from point of origin to destination and maintaining an inventory of loaded and empty containers. Most of these systems rely on transponders mounted on the containers that send messages to satellites or ground stations, from which the messages are rerouted to shipping companies, freight forwarders, and companies. However, these tracking systems are unable to guarantee that a given container does not contain contraband.

As an alternative, some present systems rely on external sensors which can inspect container contents for radiation and other items. The Vehicle and Cargo Inspection System (VACIS) sensors developed by SAIC International (and other similar systems) have proven useful in detecting unauthorized items, such as automobiles, in containers. Widespread use of VACIS will help monitor routine traffic and assist customs agents in controlling smuggling. Systems like VACIS, however, cannot prevent determined terrorists from moving dangerous items into the United States in a container because the technique is not fool-proof. Systems, like VACIS, are costly (over $300 per container movement inspected), slow the velocity of containers moving in the supply chain (because delays in U.S. government invoicing costs and clearing these costs before releasing of goods to the consignee) and is not applied to 100% of containers destined to move into the United States.

A problem with the existing technology as outlined above is that no solution is provided which enables the shipping, container to be self-evaluating and self reporting as to its status and that of its cargo. Further, problems exist with respect to integration to container security with respect to the increasingly important area of RFID inventory tracking.

### SUMMARY OF THE PRESENT INVENTION

The present invention seeks to apply the technique of stacking multiple layers of security to slow down and even stop attackers from gaining access to sensitive computer information and breaching the security of a closed container. Multiple security solutions create not only a deterrent but also an active defensive security system that establish security “gates”.

To address the problems and limitations noted above, a system for monitoring the contents and status of a closed container in a multilayered echelon of sensors, alarming systems, and control elements is provided. The object of the present invention is to overcome the shortcomings disclosed in the prior art. The accompanying drawings, which are incorporated in and constitute part of the specification, illustrate various embodiments of the present invention and together with the description, serve to explain the principles of the present invention.

### BRIEF DESCRIPTION OF THE DRAWINGS

FIG. 1 is a functional configuration according to an embodiment of the present invention.

FIG. 2 is a functional configuration of a microcontroller unit according to an embodiment of the present invention.

FIG. 3 is a functional configuration of a series of security gates according to an embodiment of the present invention.

FIG. 4 is a functional configuration of a sensing control element according to an embodiment of the present invention.

### DESCRIPTION OF THE PREFERRED EMBODIMENTS

For the purposes of promoting an understanding of the principles of the present invention, reference will now be made to the embodiments illustrated in the drawings and specific language will be used to describe the same. It will nevertheless be understood that no limitation of the scope of the present invention is hereby intended and such alterations and further modifications in the illustrated devices are contemplated as would normally occur to one skilled in the art.

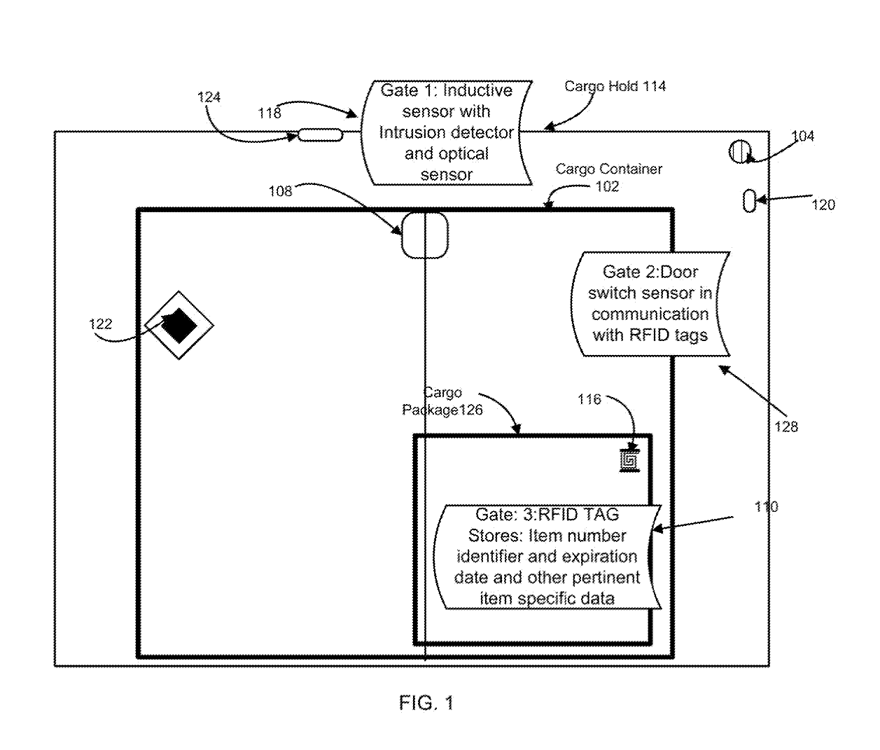

With reference now to FIG. 1, and for the purposes of explanation, the basic system of the present invention may consist of at least 3 security gates that function in a monitoring capacity. Each gate may function and perform in a stand-alone mode but in the present invention preferably the monitoring device in each gate communicates with the other devices and with the remote monitoring station to create a tamper-proof security defensive system.

As shown in FIG. 1, according to an embodiment of the present invention, Gate 1 118, comprises an inductive sensor with intrusion detectors and optical sensors. Gate 1 118 monitors all containers within the cargo hold 114. The Gate 1 security includes any sensor suites operated throughout the cargo hold such as temperature sensors 104, moisture sensors 120, and accelerometer 124. Gate 2 128, a door switch sensor in communication with RFID tags 116 and GPS locator monitors the security of a single cargo container 102. Gate 3 110 refers to security, identification, and tagging system associated with the individual packages and cargo. According to a preferred embodiment of the present invention, an RFID tag 116 is attached to a package and stores pertinent information about the item and an item number identifier.

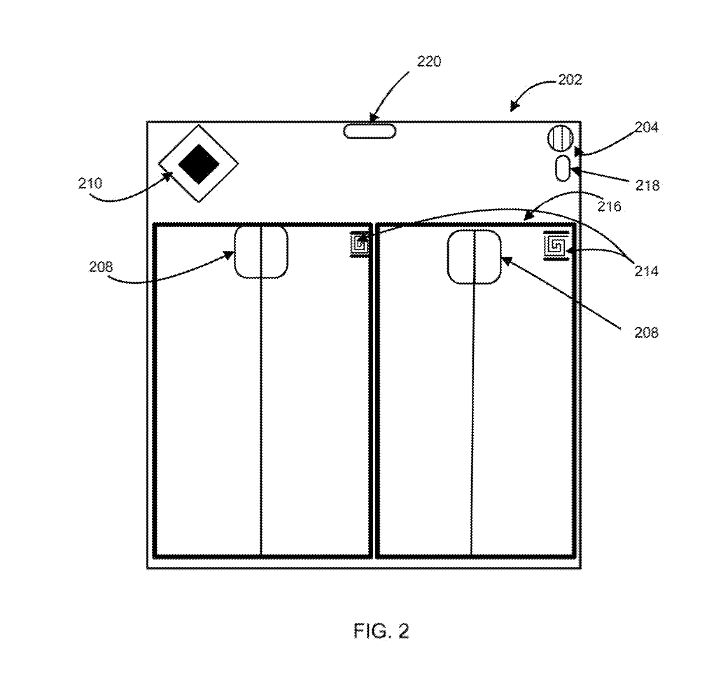

With reference now to FIG. 2, a second preferred embodiment of the present invention will now be discussed. According to a preferred embodiment of the present invention, the system of the present invention may include a door switch sensor 208 comprising a magnetic proximity sensor for monitoring the opening and closing of the door. This sensing function alternatively can be accomplished with an optical photometer or ultrasonic transducer that senses an angular change in a reflected diode light imposed on the interior of the, door. Alternatively, the door switch sensor 208 according to one embodiment of the present invention may include an optical/visual sensor, a function to record flash time/date stamp whenever the door is opened, audible and visual alarms, and house a pass-through antenna as means of improving wireless communication links by receiving RF signals from within a container and guiding RF signals outside of a container.

As further shown in FIG. 2, a RFID reader/GPS transponder device 210 within the cargo hold 202. The RFID/GPS unit comprising a RFID reader, a GPS receiver, a microcontroller unit 301, and a wireless radio transceiver. The RFID reader/GPS transponder device 210 preferably communicates with the RFID tags 214 of the individual packages in the container and sensors throughout the cargo hold 202 such as the temperature sensor 204 or a moisture sensor 218. A remote monitoring station preferably queries the RFID/GPS unit 210 to initiate an automatic data capture event. Preferably, the microcontroller unit 301 will trigger the audible and visual alarms and alert the remote monitoring station when temperatures exceed a preset condition or when moisture levels exceed a preset condition for the contents of the container. The sensor suite of the present invention may include and is not limited to: temperature sensors, visible light sensors, acoustic sensors, vibration sensors, IR motion sensors, IR micro bolometer, smoke detector, door switch, RF E-seal, container integrity sensors, moisture sensors, optical sensors, chemical and radiation sensors.

As further shown in FIG. 2, the RFID/GPS unit 210 will read each RFID tag of each item within its specific container and store the item number identifier and expiration data and any other pertinent data stored pertained to the specific item. This unit may include an RFID reader, a GPS transponder, a microcontroller unit, and a wireless transceiver. The RFID reader will send information to the microcontroller unit 301 where the GPS location coordinate will be applied to the identification code of each item; the microcontroller unit 301 will transmit information back to remote monitoring station.

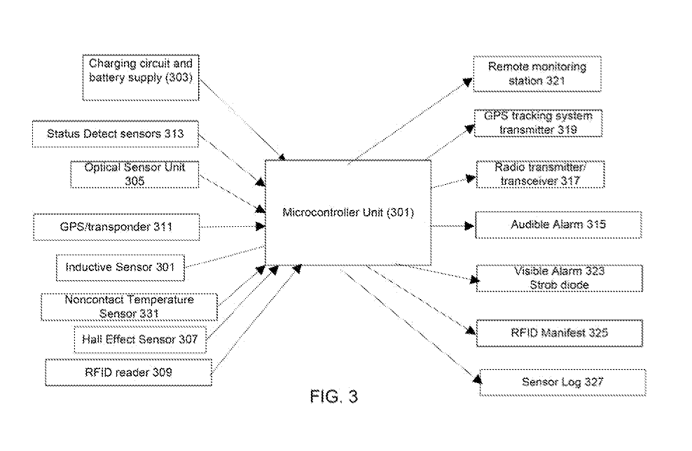

With reference now to FIG. 3, the details of a functional configuration of a microcontroller unit according to an embodiment of the present invention will now be discussed. A microcontroller unit 301 receives input from a charging circuit and battery cells 303, a RFID reader 309, the status detect sensors 313 and a GPS transponder 311. The microcontroller unit 301 then assesses all the information and sends out signals to a radio transmitter/transceiver 317, a GPS tracking system transmitter 319, a RFID manifest 325, a sensor log 327, and a remote monitoring station 321. Data from the RFID/GPS unit 210 is processed, stored, and acted upon by the microcontroller unit 301.

In operation, the microcontroller unit 301 is preferably programmed to routinely scan the conditions of the sensors to ensure operability. It may be further preferable; that the microcontroller unit 301 have access to all other subsystem managers of the Sensor, communications, power, and alerting functions. To achieve this function, it is preferred that the controller 301 has access to and handles all of the system logging of sensor data on a sensor log 327 or similar medium.

Preferably, the RFID tag encodes pertinent security and handling information which may be used to modify predetermined alarm conditions based on information associated with the RFID tag. For example, in the case that a vehicle is initially transporting canned goods, the system may identify the cargo and create or use a predetermined alarm or monitoring condition for the transportation conditions appropriate for canned goods. Thereafter, should the same vehicle be loaded with different or additional cargo, the system would again identify the cargo and then modify, create or select the appropriate alarm or monitoring conditions for the new cargo mix. For example, should the vehicle transporting canned goods pick up a load of penicillin, the system would identify the new penicillin cargo and create or use a range of transportation/environmental factors more appropriate for monitoring the new cargo mix. According to a preferred embodiment, the new transportation/environmental factors could be used to adjust alarm conditions, generate a report for the driver or trigger changes in routing information. Still further, the system may use the cargo data to automatically adjust the environmental conditions within the cargo hold.

According to a further aspect of the invention, the RFID tag may be used only to identify the cargo and the system may be configured to access additional data to determine the appropriate transportation requirements for the identified cargo. For instance, the system may include a memory element for storing appropriate requirements for lists of goods. Still further, the system may include a network element which may access handling data from remote sources and databases (i.e. via the Internet or other connection).

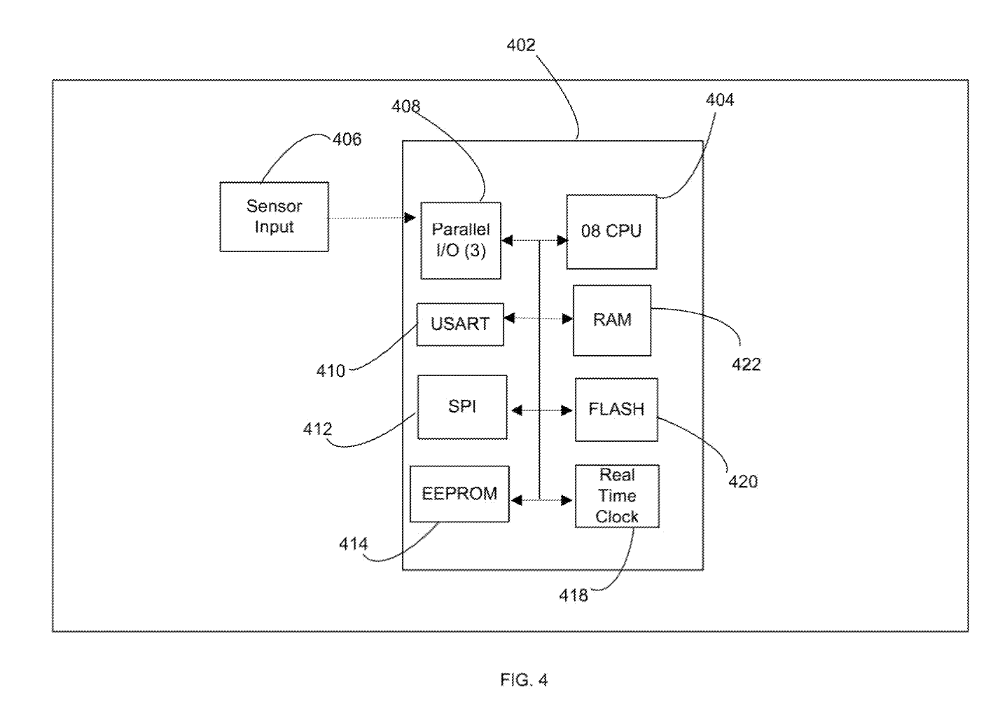

With reference now to FIG. 4, it is preferred that the microcontroller unit 402 incorporates a microprocessor 404, a real time clock 418, a general purpose Input/Output port to support external peripheral control 408, a Universal Synchronous/Asynchronous Receiver Transmitter (USART) 410, a Serial Port Interface (SPI) 412, and memory such as RAM 422, FLASH memory 420, and EEPROM 414 as shown.

Preferably, the microprocessor 304 used may be a low power, high performance, eight-bit intergrated circuit based on the Motorola HCS08 instruction set. Such a chip, for instance the NCL08 microcontroller, will preferably use an event driven power management technique to reduce power consumption by half, compared with alternative microprocessors. The controller will preferably manage power and host the master date-time clock, communication scheduling and annotation of flash memory records.

### Communication System

In accordance with a preferred embodiment of the present invention, the reporting may be made via a wireless connection to a satellite mode to communicate with a satellite system such as Globalstar or Orbcomm. Preferably, such a satellite device will be a device such as the Axxon, AutoTracker, or the like, or a customized Orbcomm VHF satellite GPS tracking communications device which may be adapted with Zigbee interface antenna devices to incorporate them into the overall LAN architecture of the security system. These devices include a satellite transceiver, GPS receiver, a customized Zigbee wireless antenna with a serial (Ax Tracker) or duplex (OrbComm) interface.

In accordance with an alternative preferred embodiment of the present invention, the reporting may also be made using a wireless system independent from the satellite system. According to this embodiment, wireless signals may be transmitted to a wireless relay, base station or the like for routing and transmission to a chosen centralized location independent from or in combination with the transmissions made from the satellite system. In accordance with this alternative embodiment, signals may also be received by the communications manager and wireless interface from such external wireless networks as well.

According to a preferred embodiment of the present invention, it is preferred that the wireless communications used within the present invention will be based on the Zigbee (IEEE 802.15.4) standard. This standard transmits RF signals in the 2.4 GHz ISM band and operates with low power consumption due to its relatively slower data transmission rate (128 Kpps-250 Kbps). This approach enables additional capacity and flexibility of design through an up to 255 node pico-network. Communications are simplex or duplex in design, meaning that data can be assessed in either a push or pull process.

As referred to above, all communications of the present invention may be designed to be duplex or simplex in nature. Further, as needs require, the processes for transmitting data to and from the present invention may be designed to be push or pull in nature. Still thither, each feature of the present invention may be made to be remotely activated and accessed from distant monitoring stations. Accordingly, data may preferably be uploaded to and downloaded from present invention as needed. For example, as detailed above, each system and subsystem of the present invention may be designed to send, receive, report and request information via the wireless and/or satellite systems so as to continually maintain and update the container systems.

Additional communications with the communications manager are preferably enabled via industry standard wired interfaces, with communications protocols implemented in firmware for future upgrade. These interfaces preferably will include at least two RS-322 compatible serial ports. These alternate serial ports may assist the communications manager to interface with additional remote sensors as well as other local reader/controllers such as-an RFID reader or other devices.

### Remote Monitoring

To support and monitor the dataflow generated by the present invention, it is preferred that users establish a centralized location to collect and analyze data. This central location or “data fusion center” would preferably consolidate all tracking signals, sensor alarms and reports generated by the monitoring systems and provide further context and links with current intelligence.

Preferably, such a data fusion center will receive such source information in a variety of formats such as Electronic Data Interchange, XML, E-mail, HTML and flat text files. After receiving such data, the data fusion center preferably would act to process information to identify anomalies. With this data collected and processed, analysts may calculate statistics and probability of detection models used for decision support. In short, such a data fusion center would preferably provide a consolidated source of information that could be used to assist agencies and shippers.

What is claimed is:

1. A method for monitoring a container for transporting goods which are identified by one or more RFID tags, the method comprising:
reading an RFID tag associated with a first item to be transported;
determining a proper storage condition for the first item;
selecting an alarm condition based on the determined proper storage condition for the first item;
reading an RFID tag associated with a second item to be transported;
determining a proper storage condition for the second item;
selecting an alarm condition based on the determined proper storage condition for the second item;
monitoring the container to determine storage conditions;
setting the storage conditions within the container based on the determined storage condition for the first item; and
adjusting the storage conditions within the container based on the determined storage condition for the second item.

2. The method of claim 1, wherein the storage conditions for the first item are determined by accessing a database.

3. The method of claim 2, wherein the database is accessed via the internet.

4. The method of claim 3, wherein the method further includes creating a new storage condition which is determined by combining storage conditions for the first item and the second item.

5. The method of claim 4, wherein the method further includes transmitting the determined proper storage condition to a point outside the container.

6. An apparatus for monitoring a container for transporting at least a first item and a second item which are identified by one or more RFID tags, the apparatus comprising:
an RFID tag reader configured for reading at least RFID tags associated with a first item and a second item to be transported;
a processing element for determining a proper storage condition for the first item;
an alarming element for selecting an alarm condition based on the determined storage conditions for the first item;
a processing element for determining a proper storage condition for the second item;
an alarming element for selecting an alarm condition based on the determined storage conditions for the second item; and
a monitoring element for monitoring the storage conditions of the container.

7. The apparatus of claim 6, wherein the apparatus further comprises an environmental control element for setting the storage conditions within the container based on the determined storage condition for the first item and adjusting the storage conditions within the container based on the determined storage condition for the second item.

8. The apparatus of claim 6, wherein the apparatus further comprises a communications element.

9. The apparatus of claim 8 wherein the apparatus further comprises a locating and tracking element.

10. The apparatus of claim 9, wherein the apparatus further comprises a memory element

11. The apparatus of claim 10, wherein the environmental control element includes an external sensing system, comprising at least one sensor external to the container for monitoring the immediate surroundings of the cargo container.

12. The apparatus of claim 11, wherein the communications element is external to the container and communicates with sensors within the container.

13. The apparatus of claim 12, wherein the monitoring element includes a plurality of sensors.

14. The apparatus of claim 13, wherein the sensors include at least one sensor from the group of sensors containing: temperature sensors, visible light sensors, acoustic sensors, vibration sensors, IR motion sensors, IR micro bolometer, smoke detector, door switch, RF E-seal, container integrity sensors, moisture sensors, optical sensors, chemical and radiation sensors.

15. The apparatus of claim 14, wherein the locating element measures the relative location of the first item and the second item and further wherein the processing element determines improper positioning of the first item relative to the second item triggering an alarm.

16. An apparatus for monitoring a container for transporting at least a first item and a second item which are identified by one or more RFID tags, wherein the apparatus comprises a processing element configured to:
receive input from an RFID reader regarding a first item to be transported;
determine a proper storage condition for the first item;
select an alarm condition based on the determined proper storage condition for the first item;
receive input from an RFID reader regarding a second item to be transported;
determine a proper storage condition for the second item;
select an alarm condition based on the determined proper storage condition for the second item;
receive data regarding storage conditions in the container;
set the storage conditions within the container based on the determined storage condition for the first item; and
adjust the storage conditions within the container based on the determined storage condition for the second item.
